(19) United States
(12) Patent Application Publication
(10) Pub. No.: US 2013/0023211 A1
(43) Pub. Date: Jan. 24, 2013

(54) ELECTRONIC DEVICE AND COMMUNICATION STATE OUTPUT METHOD

(71) Applicant: Kabushiki Kaisha Toshiba, Tokyo (JP)

(72) Inventor: Gen Watanabe, Tokyo (JP)

(73) Assignee: KABUSHIKI KAISHA TOSHIBA, Tokyo (JP)

(21) Appl. No.: 13/629,102

(22) Filed: Sep. 27, 2012

Related U.S. Application Data
(63) Continuation of application No. 12/555,726, filed on Sep. 8, 2009.

(30) Foreign Application Priority Data
Nov. 28, 2008 (JP) 2008-305290

(51) Int. Cl. H04B 5/00

(52) U.S. Cl. 455/41.1

(57) ABSTRACT

According to one embodiment, an electronic device includes a communication module, an electrical field strength detector, a state detector, an output module, and an output controller. The communication module transmits and receives a radio signal. The electrical field strength detector detects electrical field strength of the radio signal transmitted and received by the communication module. The state detector detects a first state where the electrical field strength detected by the electrical field strength detector increases with the lapse of time and a second state where the electrical field strength detected by the electrical field strength detector decreases with the lapse of time. The output controller controls output from the output module based on the first state and the second state.

### CROSS-REFERENCE TO RELATED APPLICATIONS

This application is a continuation of U.S. patent application Ser. No. 12,555,726, filed Sep. 8, 2009, which is based upon and claims the benefit of priority from Japanese Patent Application No. 2008-305290, filed Nov. 28, 2008, the entire contents of each of which are incorporated herein by reference.

### BACKGROUND

1. Field

One embodiment of the invention relates to an electronic device that performs wireless communication, and a communication state output method thereof.

2. Description of the Related Art

In recent years, short-range wireless communication systems have been in widespread use that enable communication in a short distance of about a few centimeters. The short-range wireless communication is often applied to, for example, electronic money and a contactless IC card that is passed over a reader/writer at a ticket gate of a station. With a short-range wireless communication technology, a wireless communication module is downsized, and thereby wireless communication is available with low power consumption using a weak radio wave. In the case of short-range wireless communication with a contactless IC card, a small amount of data are communicated in a short period of time. Accordingly, even if the contactless IC card is not precisely placed over an electronic device that communicates therewith, stable communication can easily be achieved.

Besides, a new short-range wireless communication standard called “Transfer Jet” has been studied, in which communication is performed at high speed to increase the amount of data transmitted per unit of time. Because of enabling high-speed data transfer, short-range wireless communication based on this standard is expected to be used in fields that require a large amount of data transfer. An electronic device includes a coupler that transmits/receives a radio signal. When the coupler is placed over a coupler of a device to communicate with, short-range wireless communication is performed between them. In the short-range wireless communication, for example, the electronic devices can communicate with each other when the couplers are brought close together within a distance of 30 mm, and the transfer rate can be increased when they are placed at positions where the electrical field strength of a radio signal (radio wave) is high.

That is, to transfer a large amount of data in a short period of time, a user needs to place the couplers of electronic devices that perform short-range wireless communication at appropriate positions, where the electrical field strength is high, and also maintain the state.

For example, Japanese Patent Application Publication (KOKAI) No. 2004-320762 discloses a conventional wireless communication device that detects the state of wireless communication based on the electrical field strength of a received radio wave, and a message of receiver sensitivity information is displayed based on the communication state. The conventional wireless communication device detects the electrical field strength of a received radio wave, an error rate, or the like, and is thus capable of indicating that video and audio data are interrupted, a communication channel is being changed to another, the device is connected to another device, and the device is located outside the communication area.

As described above, to achieve stable high-speed data transfer in short-range wireless communication, it is preferable to appropriately position couplers provided to electronic devices that perform communication, respectively. However, when an electronic device that performs short-range wireless communication with another device is, for example, a digital camera in a unique shape or a digital video camera having a relatively large housing, it is difficult to position its coupler with respect to that of the other device by visual check.

The above conventional wireless communication device detects the electrical field strength of a received radio wave, and is only capable of checking whether communication is interrupted.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a personal computer (PC) according to an embodiment of the invention;

FIG. 2 is an exemplary block diagram of the PC in the embodiment;

FIG. 3 is an exemplary schematic diagram for explaining a state notification process in the embodiment;

FIG. 4 is an exemplary flowchart of the state notification process in the embodiment; and

FIG. 5 is another exemplary flowchart of the state notification process in the embodiment.

### DETAILED DESCRIPTION

Various embodiments according to the invention will be described hereinafter with reference to the accompanying drawings. In general, according to one embodiment of the invention, an electronic device comprises a communication module, an electrical field strength detector, a state detector, an output module, and an output controller. The communication module is configured to transmit and receive a radio signal. The electrical field strength detector is configured to detect electrical field strength of the radio signal transmitted and received by the communication module. The state detector is configured to detect a first state where the electrical field strength detected by the electrical field strength detector increases with the lapse of time and a second state where the electrical field strength detected by the electrical field strength detector decreases with the lapse of time. The output controller is configured to control output from the output module based on the first state and the second state.

According to another embodiment of the invention, there is provided a communication state output method applied to an electronic device provided with an output module. The communication state output method comprising: a communication module transmitting and receiving a radio signal; an electrical field strength detector detecting electrical field strength of the radio signal transmitted and received by the communication module; a state detector detecting a first state where the electrical field strength detected by the electrical field strength detector increases with the lapse of time and a second state where the electrical field strength detected by the electrical field strength detector decreases with the lapse of time; and an output controller controlling output from the output module based on the first state and the second state.

An electronic device according to an embodiment of the invention is described below by way of example as a notebook personal computer (PC) or a digital camera. In the following, a description will be given of the case where short-range wireless communication is performed between a PC and a digital camera.

Note that the electronic device of the embodiment need not necessarily be a PC or a digital camera. The electronic device of the embodiment may be any device provided with a processor that executes a program such as, for example, a mobile telephone, a personal digital assistant (PDA), a portable audio/video player. a digital video camera, and a portable car navigation system.

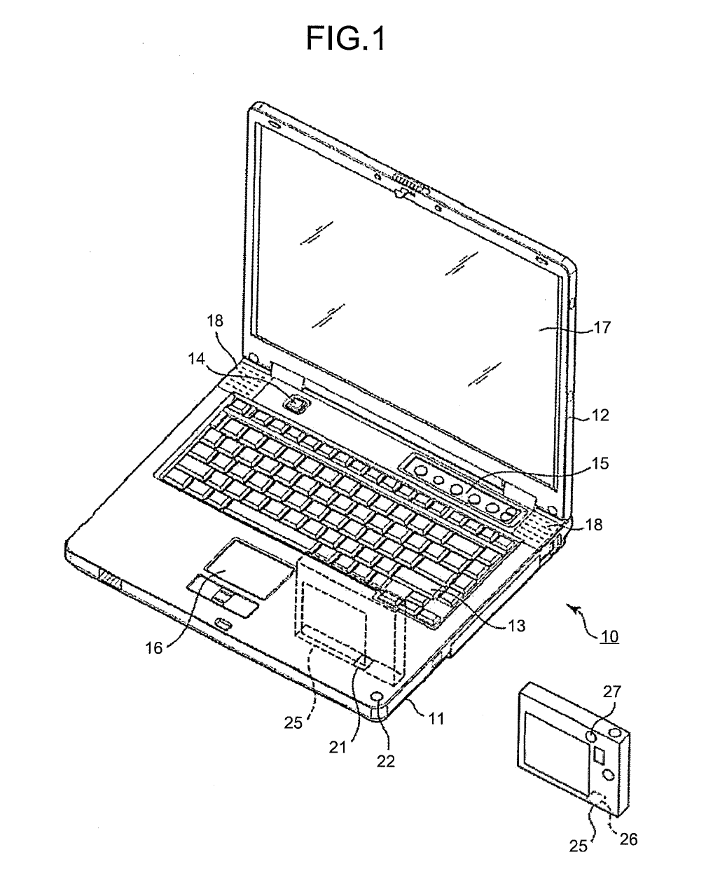

FIG. 1 is a perspective view of a PC 10 according to the embodiment. The PC 10 comprises a PC main body 11 and a display module 12. The display module 12 comprises a display device including a liquid crystal display (LCD) 17.

With respect to the PC main body 11, the display module 12 is rotatable between an open position and a closed position. In the open position, the display module exposes the upper surface of the PC main body 11. On the other hand, in the closed position, the display module covers over the upper surface of the PC main body 11. FIG. 1 illustrates the PC 10 with the display module in the open position. The PC main body 11 has a flat box-like housing, on which are arranged a keyboard 13, a power button 14, an input operation panel 15, a touchpad 16, and a speaker 18. The power button 14 is used to turn on/off the PC 10.

The input operation panel 15 comprises a plurality of buttons to perform a plurality of functions, respectively, and is an input device that receives input of an event corresponding to one of the buttons pressed.

In a portion called “palm rest” on the upper surface of the PC main body 11, a coupler 21 is arranged to transmit/receive a radio signal through short-range wireless communication. The PC 10 has a short-range wireless communication function to perform wireless communication with another electronic device while in close proximity thereto. The PC 10 communicates data with the other electronic device through the coupler 21.

Near the coupler 21 is provided an indicator 22 formed of a light emitting device such as a light emitting diode (LED). The indicator 22 is used to notify the user of changes in the electrical field strength of a radio signal (radio wave) received from another electronic device to communicate with by short-range wireless communication.

Meanwhile, an digital camera 25 illustrated in FIG. 1 also has a short-range wireless communication function to perform wireless communication with the PC 10 while in close proximity thereto. The digital camera 25 comprises a coupler 26 at, for example, the bottom of its housing to transmit/receive a radio signal through short-range wireless communication. The digital camera 25 further comprises an indicator 27 formed of a light emitting device such as an LED on, for example, the back of the housing, where a display panel is generally provided. As with the indicator 22 of the PC 10, the indicator 27 is used to notify the user of changes in the electrical field strength of a radio signal (radio wave) received from another electronic device to communicate with by short-range wireless communication.

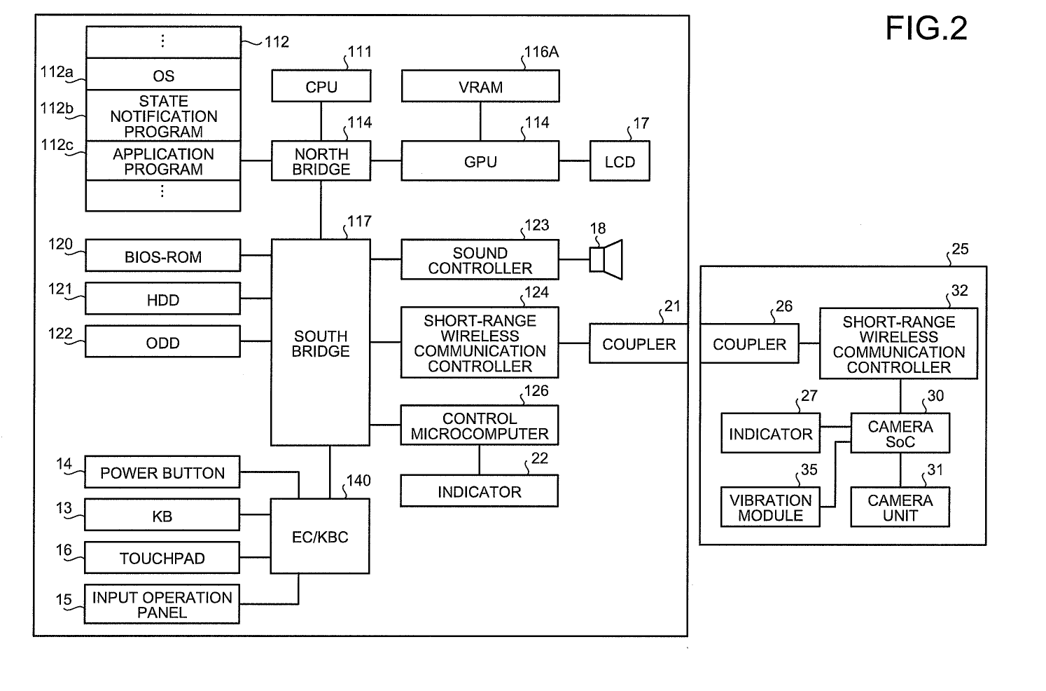

With reference to FIG. 2, the system configuration of the PC 10 will be described. As illustrated in FIG. 2, the PC 10 comprises a CPU 111, a main memory 112, a north bridge 114, a graphics processing unit (GPU) 116, a south bridge 117, a BIOS-ROM 120, a hard disk drive (HDD) 121, an optical disk drive (ODD) 122, a sound controller 123, a short-range wireless communication controller 124, a control microcomputer 126, and an embedded controller/keyboard controller (EC/KBC) IC 140.

The CPU 111 controls the operation of the PC 10. The CPU 111 loads from the HDD 121 an operating system (OS) 112a, a state notification program 112b, and various other application programs 112c into the main memory 112 to execute them.

The state notification program 112b is executed to perform a state notification process. More specifically, when the PC 10 is required to communicate data with another electronic device (such as the digital camera 25) by short-range wireless communication due to the execution of one of the application programs 112c, the state notification process is performed to support the user to easily position the coupler 21 of the PC 10 with respect to the coupler of the other electronic device.

The short-range wireless communication controller 124 has the electrical field strength detection function for detecting electrical field strength. When executing the state notification program 112b, the CPU 111 detects a first state where the electrical field strength detected by the short-range wireless communication controller 124 increases with the lapse of time, and a second state where the electrical field strength decreases with the lapse of time. According to the first state or the second state, the CPU 111 controls the output of the indicator 22 through the control microcomputer 126.

The north bridge 114 connects between a local bus of the CPU 111 and the south bridge 117. The north bridge 114 comprises a built-in memory controller that controls access to the main memory 112. The north bridge 114 has the function of communicating with the GPU 116 through a PCI Express bus or the like.

The GPU 116 is a display controller that controls the LCD 17 used as a display monitor of the PC 10. The GPU 116 generates, from display data written to a video random access memory (VRAM) 116A by the OS 112a or the application programs 112c, a video signal to display a screen image on the LCD 17.

The south bridge 117 comprises a built-in integrated drive electronics (IDE) controller or a serial ATA controller for controlling the HDD 121 and the ODD 122.

The HDD 121 stores various programs and data. The HDD 121 stores various types of data to be processed by the application programs 112c.

The ODD 122 drives storage media, such as DVD, that store video content.

The sound controller 123 is a sound source device that performs processing to output sound corresponding to various types of audio data from the speaker 18 under the control of the CPU 111.

The short-range wireless communication controller 124 performs short-range wireless communication with another electronic device through the coupler 21 under the control of the CPU 111. In the short-range wireless communication of the embodiment, it is assumed, for example, that data communication is available when the coupler 21 is brought close to that of the other electronic device within a distance of 30 mm. The short-range wireless communication controller 124 has the electrical field strength detection function for detecting electrical field strength based on a radio signal received through the coupler 21. The electrical field strength detected by the electrical field strength detection function is read, for example, at regular intervals (per unit of time), in the state notification process performed by the CPU 111.

The control microcomputer 126 controls the driving of the indicator 22 under the control of the CPU 111 according to the state notification process. In response to an instruction from the CPU 111, the control microcomputer 126 is capable of controlling the change of lighting/blinking of the indicator 22, the blinking interval thereof, the display color thereof, and the like.

The EC/KBC IC 140 is a one-chip microcomputer comprising the integration of an embedded controller for power management and a keyboard controller for controlling the keyboard (KB) 13 and the touchpad 16. The EC/KBC IC 140 is always supplied with power from a power supply circuit (not illustrated) even while the PC 10 is OFF. The EC/KBC IC 140 functions as a controller to control the input operation panel 15.

The EC/KBC IC 140 has the function of turning on/off the PC 10 in response to user's operation on the power button 14. The ON/OFF control of the PC 10 is performed in cooperation by the EC/KBC IC 140 and the power supply circuit. The power supply circuit generates operation power supplied to each of the constituent elements by using power fed from a battery connected to the PC main body 11 or power fed from an AC adaptor connected as an external power supply to the PC main body 11.

On the other hand, as illustrated in FIG. 2, the digital camera 25 comprises a camera system on chip (SoC) 30, a camera unit 31, a short-range wireless communication controller 32, a vibration module 35, the coupler 26, and the indicator 27.

The camera SoC 30 controls the overall operation of the digital camera 25. The camera SoC 30 controls the camera unit 31 to capture an image (a still image, a moving image, etc.) and store image data thereof in a storage medium (not illustrated). The image data stored in the storage medium can be transferred to the PC 10 through short-range wireless communication and stored therein.

The camera SoC 30 executes a state notification application installed thereon in advance to perform a state notification process. More specifically, when the digital camera 25 is required to communicate data with another electronic device (such as the PC 10) by short-range wireless communication, the camera SoC 30 performs the state notification process to support the user to easily position the coupler 26 of the digital camera 25 with respect to the coupler of the other electronic device.

The short-range wireless communication controller 32 has the electrical field strength detection function for detecting electrical field strength. When executing the state notification application, the camera SoC 30 detects a first state where the electrical field strength detected by the short-range wireless communication controller 32 increases with the lapse of time, and a second state where the electrical field strength decreases with the lapse of time. According to the first state or the second state, the camera SoC 30 controls the output of the indicator 27 or the driving of the vibration module 35. By the state notification process, the camera SoC 30 is capable of controlling the change of the lighting/blinking of the indicator 27, the blinking interval thereof, the display color thereof, and the like. In addition, by the state notification process, the camera SoC 30 is also capable of controlling the activation/deactivation of the vibration module 35, the vibration interval thereof, and the like.

The camera unit 31 captures an image under the control of the camera SoC 30, and stores image data thereof in the storage medium.

The short-range wireless communication controller 32 performs short-range wireless communication with another electronic device through the coupler 26 under the control of the camera SoC 30. In the short-range wireless communication of the embodiment, it is assumed, for example, that data communication is available when the coupler 26 is brought close to that of the other electronic device within a distance of 30 mm. The short-range wireless communication controller 32 has the electrical field strength detection function for detecting electrical field strength based on a radio signal received through the coupler 26. The electrical field strength detected by the electrical field strength detection function is read, for example, at regular intervals (per unit of time), in the state notification process performed by the camera SoC 30.

The vibration module 35 is driven by the camera SoC 30, and the activation/deactivation of its vibration and the vibration interval can be changed.

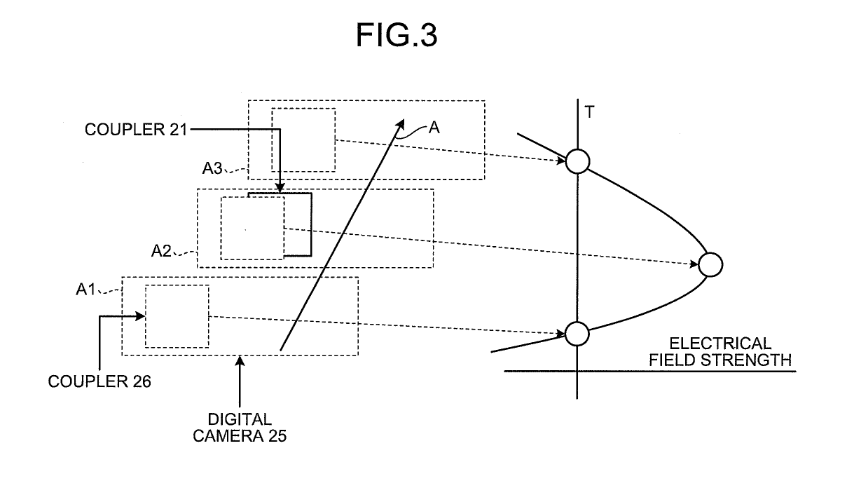

With reference to FIG. 3, a schematic description will be given of the state notification process for short-range wireless communication of the embodiment. FIG. 3 illustrates changes in electrical field strength when the coupler 26 of the digital camera 25 is passed as indicated by arrow A in close proximity to the coupler 21 of the PC 10.

In the PC 10, the short-range wireless communication controller 124 detects electrical field strength based on a communication signal received by the coupler 21. Similarly, in the digital camera 25, the short-range wireless communication controller 32 detects electrical field strength based on a communication signal received by the coupler 26. The changes in electrical field strength illustrated in FIG. 3 are assumed herein to be detected by the PC 10 (the digital camera 25 also detects electrical field strength as with the PC 10).

When the digital camera 25 is located at a position A1 in FIG. 3, the distance between the PC 10 and the digital camera 25 does not allow short-range wireless communication between the coupler 21 and the coupler 26. In this case, the electrical field strength is zero.

From the position A1, as the digital camera 25 moves in the direction indicated by arrow A, the distance between the coupler 26 of the digital camera 25 and the coupler 21 of the PC 10 becomes shorter. When the digital camera 25 is brought closer to the PC 10 and the coupler 26 enters the range of short-range wireless communication with the coupler 21, the electrical field strength increases as the distance decreases.

When the digital camera 25 is located at a position A2 in FIG. 3, the coupler 26 of the digital camera 25 is the closest to the coupler 21 of the PC 10. Thus, the electrical field strength detected at this point is the highest.

From the position A2, as the digital camera 25 further moves in the direction indicated by arrow A, the distance between the coupler 26 of the digital camera 25 and the coupler 21 of the PC 10 increases. The electrical field strength decreases as the distance between the coupler 26 and the coupler 21 increases.

According to the embodiment, in the state notification process, the PC 10 detects the first state where the electrical field strength increases as the digital camera 25 moves from the position A1 to the position A2 in FIG. 3. The PC 10 also detects the second state where the electrical field strength decreases as the digital camera 25 moves from the position A2 to a position A3 in FIG. 3. The output mode of the indicator 22 varies according to the first state and the second state. With this, the user who is operating the digital camera 25 can easily recognize whether the coupler 26 of the digital camera 25 is brought close to the coupler 21 of the PC 10 or it is brought away therefrom. Thus, even if incapable of directly viewing the coupler 21 of the PC 10 and the coupler 26 of the digital camera 25, the user can position the digital camera 25 at the position A2 in FIG. 3 where the electrical field strength is the highest while checking the change in the output mode of the indicator 22.

A description will now be given of data transfer between the PC 10 and the digital camera 25 through short-range wireless communication. It is assumed herein that the PC 10 and the digital camera 25 have the short-range wireless communication function based on the same standard. When image data stored in the digital camera 25 is transferred to the PC 10, the image data to be transferred is selected, and an instruction is issued to perform short-range wireless communication. When short-range wireless communication becomes available with the PC 10 (the coupler 21) through the coupler 26, the digital camera 25 starts processing for data transfer.

On the other hand, when short-range wireless communication becomes available with another electronic device (the digital camera 25), the PC 10 performs the state notification process by executing the state notification program 112b.

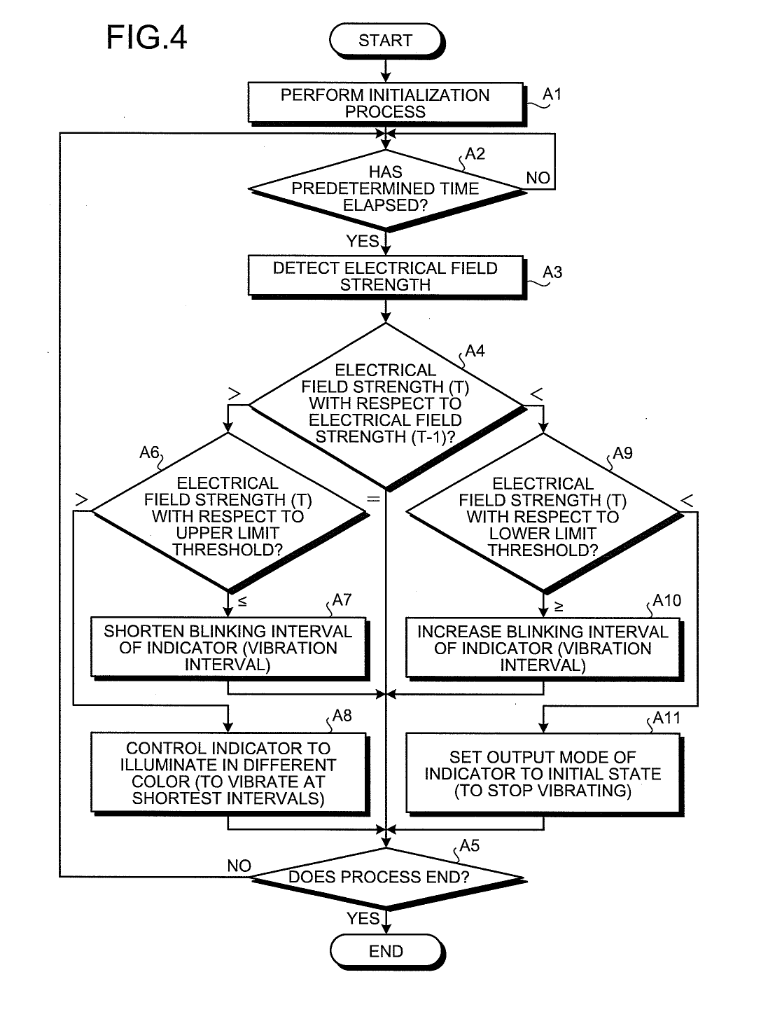

With reference to FIG. 4, a description will be given of the state notification process performed by the PC 10.

When the state notification process starts, the CPU 111 performs initialization process (A1). The term “initialization process” as used herein refers to, for example, to set the output mode of the indicator 22 to the initial state where the electrical field strength is the lowest.

When a predetermined time (unit time) has elapsed (A2), the CPU 111 detects the electrical field strength of a communication signal (radio wave) detected by the coupler 21 with the electrical field strength detection function of the short-range wireless communication controller 124 (A3).

The CPU 111 compares the electrical field strength (T) detected this time with the electrical field strength (T−1) detected before a predetermined time (T−1) (A4).

If the electrical field strength (T) is higher than the electrical field strength (T−1) (“>” at A4), the CPU 111 determines that the electrical field strength is in the first state where the electrical field strength increases with the lapse of time.

The CPU 111 then compares the electrical field strength (T) with an upper limit threshold preset for electrical field strength (A6). If the electrical field strength (T) is equal to or lower than the upper limit threshold (“≦” at A6), the CPU 111 shortens the blinking interval of the indicator 22 compared to that before the predetermined time (T−1) (A7).

That is, while the digital camera 25 is moving from the position A1 to the position A2 in FIG. 3, the CPU 111 determines that the electrical field strength is in the first state. As the electrical field strength increases, the blinking interval of the indicator 22 becomes shorter.

Since the blinking interval of the indicator 22 becomes shorter by moving the digital camera 25, the user can check that the digital camera 25 is brought close to a position where stable short-range wireless communication is possible.

Incidentally, the upper limit threshold is set to determine whether the couplers are in an appropriate positional relationship. More specifically, the upper limit threshold is set to the electrical field strength that allows stable high-speed data transfer by short-range wireless communication. When the electrical field strength detected by the short-range wireless communication controller 124 exceeds the upper limit threshold, a pair of electronic devices that perform short-range wireless communication are positioned such that their couplers are in a positional relationship suitable for data transfer (for example, the position A2 in FIG. 3).

As a result of the comparison between the electrical field strength (T) and the preset upper limit threshold, when the electrical field strength (T) exceeds the upper limit threshold (“>” at A6), the CPU 111 controls the indicator 22 to illuminate in a different color to indicate that both the couplers are in an optimal positional relationship (A8). By checking the change of the light color of the indicator 22, the user can determine that the coupler 26 of the digital camera 25 is positioned appropriately with respect to the coupler 21 of the PC 10.

While the indicator 22 is described above as changing from blinking to lighting steadily in a different color, this is by way of example only. Any other output modes may be preset to the indicator 22 to indicate that both the couplers are in an optimal positional relationship. For example, the indicator 22 may change from blinking to lighting steadily without changing the display color. The indicator 22 may also change from blinking in a regular pattern to blinking in a predetermined irregular pattern. Alternatively, the indicator 22 may change only the display color while blinking at the shortest intervals.

As a result of the comparison between the electrical field strength (T) and the electrical field strength (T−1) detected before the predetermined time (T−1), if the electrical field strength (T−1) is higher than the electrical field strength (T) (“<” at A4), the CPU 111 determines that the electrical field strength is in the second state where the electrical field strength decreases with the lapse of time.

The CPU 111 then compares the electrical field strength (T) with a lower limit threshold preset for electrical field strength (A9). If the electrical field strength (T) is equal to or higher than the lower limit threshold (“≧” at A9), the CPU 111 increases the blinking interval of the indicator 22 compared to that before the predetermined time (T−1) (A10).

That is, while the digital camera 25 is moving from the position A2 to the position A3 in FIG. 3, the CPU 111 determines that the electrical field strength is in the second state. As the electrical field strength decreases, the blinking interval of the indicator 22 becomes longer.

Since the blinking interval of the indicator 22 becomes longer by moving the digital camera 25, the user can check that the digital camera 25 is brought away from a position where stable short-range wireless communication is possible.

In other words, by moving the digital camera 25 near the coupler 21 of the PC 10, the user can determine the optimal position where the light color of the indicator 22 changes while checking the blinking interval of the indicator 22 which becomes shorter or longer.

Incidentally, the lower limit threshold is set to determine whether short-range wireless communication is not possible. More specifically, the lower limit threshold is set to the electrical field strength that is not suitable for data transfer by short-range wireless communication. When the electrical field strength detected by the short-range wireless communication controller 124 is lower than the lower limit threshold, a pair of electronic devices that perform short-range wireless communication are positioned such that their couplers are in a positional relationship not suitable for data transfer (for example, the position A3 in FIG. 3).

As a result of the comparison between the electrical field strength (T) and the lower limit threshold preset for electrical field strength, when the electrical field strength (T) is lower than the lower limit threshold (“<” at A9), the CPU 111 resets the output mode of the indicator 22 to the initial state to indicate that both the couplers are in a positional relationship unsuitable for short-range wireless communication (A11).

As a result of the comparison between the electrical field strength (T) and the electrical field strength (T−1), if the electrical field strength (T) is equal to the electrical field strength (T−1) (“=” at A4), the CPU 111 does not change the output mode of the indicator 22.

Upon completion of data transfer through short-range wireless communication, the state notification process ends (Yes at A5).

As described above, the CPU 111 detects the electrical field strength of a communication signal received by the coupler 21 at regular intervals. The CPU 111 compares the electrical field strength with that detected last time to determine whether the electrical field strength is in the first state or the second state. According to the first state or the second state, the CPU 111 changes the output mode of the indicator 22 so that the user can recognize the positional relationship between the couplers 21 and 26 of the PC 10 and the digital camera 25. When the electrical field strength exceeds the upper limit threshold, the CPU 111 determines that the couplers 21 and 26 are in an appropriate positional relationship, and thereby changes the output mode of the indicator 22 to a specific mode (display color, lighting, etc.). Thus, the user can recognize that the couplers 21 and 26 are in an optimal positional relationship without visual check, and maintain the state.

FIG. 1 illustrates the digital camera 25 in a relatively small size. In the case of a digital video camera or other electronic devices having a relatively large housing, it is generally more difficult to position the coupler. According to the embodiment, the user can easily place the coupler at an optimal position while checking the output mode of the indicator 22 regardless of the size of the housing of the electronic device.

While the state notification process is described above as being performed by the PC 10, it can be similarly performed by the digital camera 25. The digital camera 25 (the camera SoC 30) obtains the electrical field strength detected by the short-range wireless communication controller 32 at regular intervals as illustrated in FIG. 4. According to the change of the electrical field strength, the digital camera 25 (the camera SoC 30) controls the output mode of the indicator 27. Thus, the user can appropriately position the coupler 26 with respect to the coupler 21 of the PC 10 while referring to the output mode of the indicator 27 provided to the digital camera 25.

Besides, the digital camera 25 can use the vibration module 35 as an output module for the state notification process. In this case, when in the initial state, the vibration module 35 is not vibrating. Having determined that the electrical field strength is in the first state, the camera SoC 30 shortens the vibration interval of the vibration module 35 with the lapse of time (A7 in FIG. 4). On the other hand, having determined that the electrical field strength is in the second state, the camera SoC 30 increases the vibration interval of the vibration module 35 with the lapse of time (A10 in FIG. 4). When the electrical field strength (T) exceeds the upper limit threshold (“>” at A6 in FIG. 4), the camera SoC 30 controls the vibration module 35 to vibrate at the shortest intervals to indicate that both the couplers are in an optimal positional relationship (A8 in FIG. 4).

In this manner, in addition to the indicator formed of LED or the like, other modules such as the vibration module 35 may be used as an output module for the state notification process. For example, mobile telephones are provided with a vibrator as a basic function. This vibrator can be used for the state notification process.

As described above, the digital camera 25 can use both the indicator 27 and the vibration module 35 as an output module for the state notification process. The user may arbitrarily set whether to use the indicator 27 or the vibration module 35, or both of them.

In the foregoing, the PC 10 is described as being provided with the indicator 22 while the digital camera 25 is described as being provided with the indicator 27 and the vibration module 35 as an output module for the state notification process. A description will than be given of the state notification process preformed by an electronic device that is not provided with such a dedicated output module.

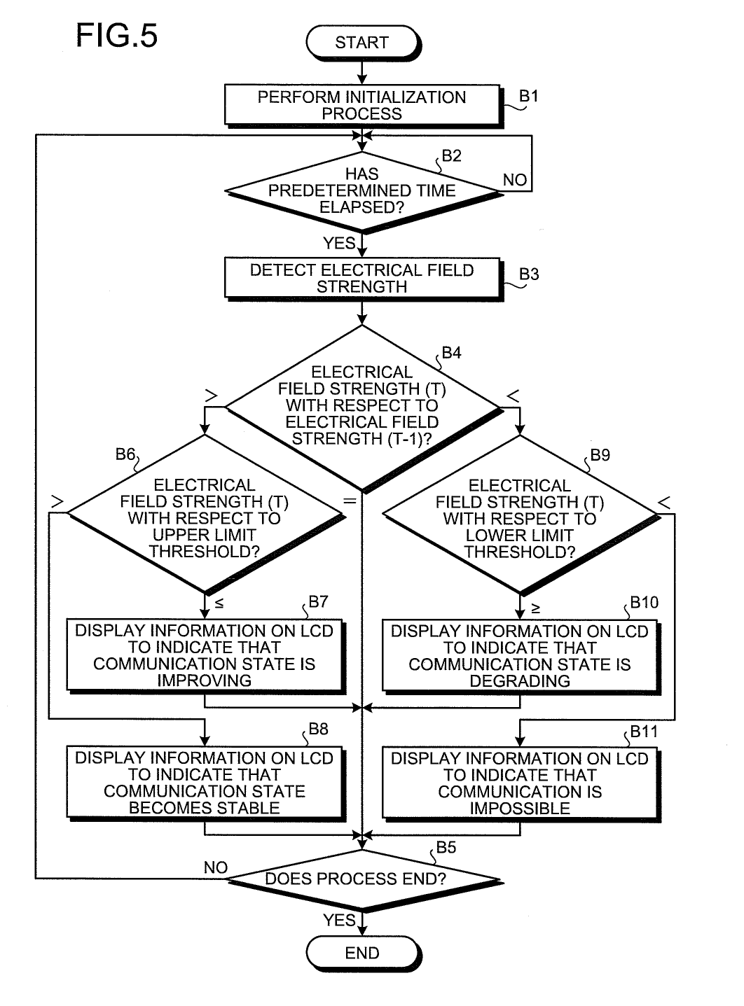

FIG. 5 is a flowchart of the state notification process preformed by an electronic device that is not provided with a dedicated module for the state notification process. This state notification process is basically similar to that illustrated in FIG. 4, and therefore, will not be described in detail (the process from B1 to B11 of FIG. 5 corresponds to that from A1 to A11 of FIG. 4).

In the state notification process described below, a display device that is generally provided to an electronic device is used as an output module. That is, an example will be described in which the LCD 17 is used as an output module for the state notification process in the PC 10. In this case, the state notification program 112b has the function of controlling the display on the LCD 17 to notify the user of the state in the state notification process.

If determining that the electrical field strength is in the first state based on the electrical field strength detected by the short-range wireless communication controller 124 (“>” at B4), and that the electrical field strength (T) is equal to or lower than the upper limit threshold (“≦” at B6), the CPU 111 displays information on the LCD 17 to indicate that the communication state is improving (B7). For example, the CPU 111 displays on the LCD 17 a graphic representing an indicator and changes the form of the graphic to indicate that the communication state is improving with the lapse of time. More specifically, the CPU 111 displays a bar-like image as an indicator, and lengthens the bar with the lapse of time, thereby indicating that the communication state is improving. Alternatively, a message may be displayed to indicate that the communication state is improving. The CPU 111 may notify the user of the information in any other display mode.

Having determined that the electrical field strength (T) exceeds the upper limit threshold (“>” at B6), the CPU 111 displays information on the LCD 17 to indicate that the communication state becomes stable (B8). In the same manner as described above, the CPU 111 may display the information indicating that the communication state becomes stable with a predetermined graphic, a message, or the like.

On the other hand, if determining that the electrical field strength is in the second state based on the electrical field strength detected by the short-range wireless communication controller 124 (“<” at B4), and that the electrical field strength (T) is equal to or higher than the lower limit threshold (“≧” at B9), the CPU 111 displays information on the LCD 17 to indicate that the communication state is degrading (B10). For example, the CPU 111 displays a bar-like image on the LCD 17 as an indicator, and shortens the bar with the lapse of time, thereby indicating that the communication state is degrading. Alternatively, a message may be displayed to indicate that the communication state is degrading. The CPU 111 may notify the user of the information in any other display mode.

Having determined that the electrical field strength (T) is lower than the lower limit threshold (“<” at B9), the CPU 111 displays information on the LCD 17 to indicate that the communication state is not suitable for short-range wireless communication (B11). In the same manner as described above, the CPU 111 may display the information indicating that the communication state is not suitable for short-range wireless communication with a predetermined graphic, a message, or the like.

As described above, the CPU 111 executes the state notification program 112b, and uses the LCD 17 as an output module for the state notification process. According to the electrical field strength of a radio signal received through short-range wireless communication, the CPU 111 changes the output mode of the LCD 17. Thus, the user can recognize the positional relationship between the couplers 21 and 26 of the PC 10 and the digital camera 25.

While the LCD 17 is described above by way of example as being used as an output module, the speaker 18 may also be used as an output module. In this case, the CPU 111 changes the audio output from the speaker 18 through the sound controller 123 according to changes in electrical field strength. Thus, the user can recognize the positional relationship between the couplers 21 and 26 of the PC 10 and the digital camera 25.

For example, the speaker 18 may output intermittent sound. The CPU 111 may shortens the pitch of the intermittent sound in the first state, while it may lengthen the pitch in the second state. When the electrical field strength (T) exceeds the upper limit threshold, the CPU 111 controls the speaker 18 to output continuous sound. Apart from them, other output sounds may also be applicable. In this manner, other modules than the LCD 17 (a display device) can be used as an output module for the state notification process.

The state notification application (the state notification program 112b) executed on a computer to implement the process described in the embodiment may be provided as being stored in a storage medium. Examples of the storage medium include a magnetic disk (a flexible disk, a hard disk, etc.), an optical disk (CD-ROM, DVD, etc.) and a semiconductor memory. The state notification application (the state notification program 112b) may also be provided through a communication medium. The computer reads the state notification application (the state notification program 112b) from the storage medium or receives it through the communication medium and execute it. Thus, the computer operates under the control of the state notification application (the state notification program 112b), and performs the state notification process as described above.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a communication module configured to transmit and receive a radio signal;
an electrical field strength detector configured to detect an electrical field strength of the radio signal received by the communication module at regular time intervals;
an output module configured to output a state of the electrical field strength detected by the electrical field strength detector;
a state detector configured to detect a first state and a second state based on an amount of change of the electrical field strength detected by the electrical field strength detector, wherein,
in the first state, the electrical field strength is greater than or equal to a lower limit threshold and less than or equal to an upper limit threshold, and the electrical field strength increases with lapse of time, and,
in the second state, the electrical field strength is greater than or equal to the lower limit threshold and less than or equal to the upper limit threshold, and the electrical field strength decreases with lapse of time; and
an output controller configured to control the output module to output in a first mode corresponding to the first state when the first state is detected by the state detector, to output in a second mode corresponding to the second state when the second state is detected by the state detector.

2. The electric device of claim 1, wherein
the state detector is configured to detect a third state where the electrical field strength detected by the electrical field strength detector is higher than the upper limit threshold, and,
when the third state is detected, the output controller is configured to control the output module to output in a third mode corresponding to the third state detected by the state detector.

3. The electronic device of claim 2, wherein
the output module is a light emitting module configured to emit light comprising blinking light, and,
in the first mode, intervals of the blinking light by the light emitting module are configured to decrease in accordance with the amount of change of the electrical field strength, and in the second mode, the intervals of the blinking light by the light emitting module are configured to increase in accordance with the amount of change of the electrical field strength.

4. The electronic device of claim 3, wherein, in the third mode, a color of the blinking light thereof is different from the colors of the blinking light in the first mode and the second mode.

5. The electronic device of claim 2, wherein
the output module is a vibration module configured to generate vibration, and,
in the first mode, intervals of the vibration by the vibration module are configured to decrease in accordance with the amount of change of the electrical field strength, and in the second mode, the intervals of the vibration are configured to increase in accordance with the amount of change of the electrical field strength.

6. The electronic device of claim 5, wherein, in the third mode, a vibration interval thereof is shorter than the vibration intervals of the first mode and the second mode.

7. The electronic device of claim 2, wherein
the output module is a display device, and,
in the first mode, information indicating that communication state is improving is displayed at the display device, and in the second mode, information indicating that communication state is degrading is displayed at the display device.

8. The electronic device of claim 2, wherein
the state detector is configured to detect a fourth state where the electrical field strength detected by the electrical field strength detector is lower than the lower limit threshold, and,
when the fourth state is detected, the output controller is configured to control the output module to output in a fourth mode corresponding to the fourth state detected by the state detector.

9. A communication state output method comprising:
detecting an electrical field strength of a radio signal received by a communication module at regular time intervals;
detecting a first state and a second state based on an amount of change of the electrical field strength detected by the electrical field strength detector, and to detect a third state, wherein
in the first state, the electrical field strength is greater than or equal to a lower limit threshold and less than or equal to an upper limit threshold, and the electrical field strength increases with lapse of time, and,
in the second state, the electrical field strength is greater than or equal to the lower limit threshold and less than or equal to the upper limit threshold, and the electrical field strength decreases with lapse of time; and
performing in a first mode corresponding to the first state when the first state is detected, and performing output in a second mode corresponding to the second state when the second state is detected.
